(19) United States
(12) Patent Application Publication
(10) Pub. No.: US 2009/0247245 A1
(43) Pub. Date: Oct. 1, 2009

(54) Improvements in or Relating to Electronic Headset Devices and Associated Electronic Devices

(76) Inventors: Andrew Strawn, Hampshire (GB); Brian Davidson, Surrey (GB); Tuomas Matila, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/721,753

(22) PCT Filed: Dec. 14, 2004
(86) PCT No.: PCT/GB2004/005233

§ 371 Date: Oct. 3, 2007

(51) Int. Cl. H04M 1/00; H04N 5/225; G10L 15/00

(52) U.S. Cl. 455/575.2; 348/376; 704/275; 348/E05.024; 704/E15.001

(57) ABSTRACT

An electronic headset comprising connectivity functionality, the connectivity functionality arranged to allow the headset to be operatively coupled to a remote associated electronic device for the transmission of signalling between the headset and the device, the headset further comprising camera functionality arranged to capture one or more images, and wherein the camera functionality is arranged to be controlled by control signalling transmitted via the connectivity functionality, the control signalling being processed by the remote associated electronic device and being sent to the electronic headset to control the camera functionality.

### FIELD OF THE INVENTION

The present invention relates to electronic headset devices, which are provided for operation/use with another associated electronic device. Specific embodiments relate to earpiece headset devices, which are often used with mobile communications devices, such as mobile phones.

The invention also relates to improvements in electronic devices, which are operatively associated with the electronic headset devices.

### BACKGROUND TO THE INVENTION

Work on electronic headset devices is ongoing.

EP1443665 outlines a conventional headset having a microphone and speakers, in which activation of a remote unit may be achieved by voice commands. The remote unit does not control any sensor/functionality within the headset, but simply sends data to the sensor (the speakers). A switch is used, mounted on one of the speakers to enable voice commands.

US2004051788 discloses a headset which comprises a microphone and display, in which the microphone may be used to control a remote camera apparatus and the images captured by the remote camera apparatus can be viewed on the headset display.

US2003025828 discloses a video recorder attached to a headset. The video recorder includes a head assembly for securing to the head of a user, a data recorder coupled to the head assembly, and a camera communicative with the data recorder coupled to the head assembly.

It is also known for electronic headsets to be used to access applications on a mobile handset, or to activate functionality of the handset, e.g. using a headset to answer a call or initiate a call by accessing the contacts list. This may be with a Bluetooth or wired connection between the headset and the mobile phone.

### SUMMARY OF THE INVENTION

In a first aspect, the present invention provides an electronic headset comprising connectivity functionality, the connectivity functionality arranged to allow the headset to be operatively coupled to a remote associated electronic device for the transmission of signalling between the headset and the device, the headset further comprising camera functionality arranged to capture one or more images, and wherein the camera functionality is arranged to be controlled by control signalling transmitted via the connectivity functionality, the control signalling being processed by the remote associated electronic device and being sent to the electronic headset to control the camera functionality.

The present invention allows a comparatively complex headset to be kept simple by removal of complex camera control signal processing to an associated remote electronic device. Simplicity also allows for miniaturisation of the headset. Control signal processing is provided from a remotely associated electronic device and transmitted to the electronic headset. The invention advantageously makes use of the often sophisticated processing capability already available in the associated electronic device.

The headset may be arranged to receive function commands to control headset functions. The function commands may comprise one or more voice commands and or actuation switch commands. The function commands may originate from an associatable remote electronic device and/or at the headset. The function commands may include enable functionality to activate connectivity between the headset and an associatable electronic device.

The headset may be arranged to transmit function commands to the associated electronic device for processing of the function commands by the device to generate control signalling sent back to the headset to control camera functionality.

The function commands are preferably provided by one or more voice commands and/or actuation switch commands received at the headset. In the case of actuation switch commands, for example, the headset/switch command may comprise a switch (or button), which is used to activate the camera functionality, and wherein activation of the switch command is processed by the associated device and appropriate control signals are sent back to the headset.

The switch command may be arranged such that voice commands are transmitted to the associated electronic device when the switch command is in an “on” status. The switch command may be arranged such that voice commands are not transmitted to the associated electronic device when the switch command is in an “off” status.

The headset may comprise audio functionality arranged to receive audio input from a user of the headset, the headset being arranged to transmit the audio input to the associated electronic device via the connectivity functionality for processing to provide control signalling to be sent back to the headset.

The audio functionality may be arranged to distinguish between audio inputs from a user, and determine that only those audio inputs corresponding to audio commands are to be transmitted to the associated electronic device.

The headset may comprise a processor arranged to distinguish and differentiate between audio voice commands.

The headset may comprise memory to store audio voice commands for use in the comparison with uttered audio voice commands. This may be useful in determining valid audio commands, which can be used to control camera functionality. The memory is preferably user-recordable. The memory may be contained in the associated electronic device.

The headset may not be able to distinguish/differentiate between camera function control inputs from a user and is adapted to rely on the associated electronic device to interpret the input from the user.

The headset may not distinguish/differentiate between audio inputs from a user. This functionality may be provided in the associated electronic device so that the electronic device can interpret the input from the user.

The headset may comprise audio functionality arranged to provide audio output to a user of the headset, and the connectivity functionality may be arranged to be operatively coupled to an associated electronic device for the transmission of audio signalling from the associated electronic device to the electronic headset to provide the audio output to the user.

The audio voice commands may be “capture”, “video”, “snap”, “take picture”, “camera on”, “camera off”, “transmit”, “record”, “zoom”, “in”, “out”, or various combinations of such words.

The audio voice commands may control audio output functionality e.g. increase/decrease volume, change balance to speakers, provide “graphic equalisation” function, change between mono and stereo output. Similarly, the audio voice commands may control audio input functionality (also mute function).

The headset is preferably arranged to perform a particular camera function on receipt of an appropriate audio voice command.

The headset may be arranged to store one or more images in the headset. This may be by use of a memory, which is preferably removable from the headset, e.g. a memory card/stick, but may be integral and non-user removable.

Preferably, the headset is arranged to transmit one or more images via the connectivity functionality to the remote associated device. This may be for storage, processing, or further transmission of one or more of the image by the remote associated device.

The headset may be arranged to directly transmit captured images to the associated handset. The use of one or more buffers in the headset may be used to facilitate this direct transmission. This may be for still and/or video images. Rather than storing images on the headset, the present invention makes use of the storage capacity already available in the associated electronic device.

The headset may be arranged to provide live transmission of one or more of the images to the connectivity functionality.

The connectivity functionality may be wired or wireless. In the case of wireless, it may be provided by short-range radio wave transmission e.g. Bluetooth transmission or WLAN. In the case of WLAN, the connectivity functionality would use a WLAN access point as an intermediary to communicate with a remote associated electronic device.

The associated electronic device may be a mobile handset conforming to one or more telecommunications standards. These may include GSM, GPRS, CDMA, TDMA, UMTS, WLAN or developments/variations thereof.

The associated electronic device may be a music player, such as an MP3/CD/digital tape/audio tape/radio player or any developments/variations of these players. The primary purpose of the music player may be to provide music (audio) output to a user. It may have other functionality.

The associated electronic device may be portable computer, such as a laptop, and may itself have further camera functionality. The electronic device is preferably portable/mobile but may be non-portable by a user. The associated electronic device may incorporate image storage and/or image capture functionality.

The headset may be an earpiece. The headset preferably comprises a microphone and speaker.

The control signalling may allow the capture of still and/or moving visual images by the camera functionality, and may be used to power the electronic headset to a higher or lower power state.

The camera functionality may comprise digital and/or optical zoom, which is controllable by the associated electronic device. The camera functionality may be arranged to move to across a scene to take images independently of the motion of a user. The camera functionality may be arranged to be positioned to take images corresponding to what the user can see.

In a second aspect, the present invention provides an electronic device having connectivity functionality, the connectivity functionality arranged to allow the electronic device to be operatively coupled to a remote electronic headset for the transmission of signalling between the device and the headset, the device further comprising control functionality arranged to process headset camera control signalling to control the operation of headset camera functionality for the capture of one or more images, the control functionality being arranged to transmit the control signalling via the connectivity functionality.

In a third aspect, the present invention provides an electronic headset and electronic device for association with the headset according to the first and second aspects of the present invention.

The present invention also provides preferred embodiments according to the second and third aspects of the invention in accordance with appropriately modified aspects of the preferred embodiments of the first aspect of the invention.

The present invention also relates to methods of controlling headset functionality.

### BRIEF DESCRIPTION OF THE FIGURES

Specific embodiments of the present invention will be described, by way of example only, with reference to the following figures in which:

FIG. 1 shows a perspective view of a basic design of a headset according to the present invention;

FIG. 2 shows a perspective view of a further developed design of a headset according to the present invention;

FIG. 3 shows a perspective view of the headset of FIG. 2 in usage;

FIG. 4 shows a schematic of the communications between a headset an associated electronic device according to the present invention.

### DESCRIPTION OF SPECIFIC EMBODIMENTS

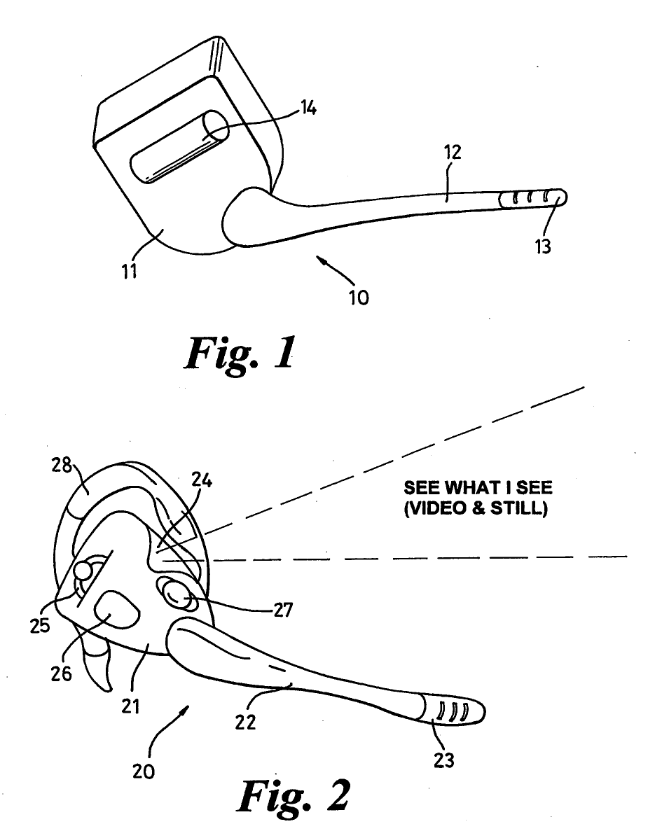

FIG. 1 shows a basic headset design according to the present invention. The headset is for communication with a mobile phone (not shown).

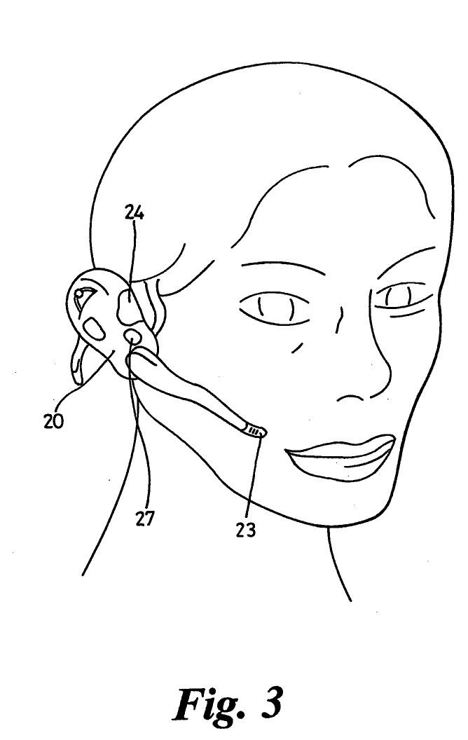

The headset is in the form of an earpiece 10 and comprises a body 11 out of which extends an adjustable boom 12, on the end of which is situated a microphone 13. The boom 12 has a length sufficient to allow the microphone 13 to pick up any sound transmissions from a user (e.g. see FIG. 3) wearing the earpiece 10. The arrangement for fixing the earpiece 10 onto a user is not shown. Also not shown is a speaker, which is housed within the body 11, and which is used to transmit sound to a user wearing the earpiece though apertures (not shown) in the rear of the body 11.

The body 11 comprises wireless technology (e.g. Bluetooth™, wireless local area network (WLAN)), which is used for communication with an associated mobile phone. This is internal to the body 11 and is not shown. The body 11 also has an integral camera 14, which is positioned to take pictures (video/still) in the forward direction when in use. The earpiece 10 and camera 14 are arranged such that, in use, the camera 14 is able to see what the user sees. In this case, the camera 14 projects out of the body 11 of the earpiece 10.

The earpiece 10 comprises an internal power source, such as a rechargeable battery, and one or more connections (not shown) to allow recharging. A processor (not shown), powered by the power source, is also provided to control the function of the audio (microphone 13, speaker), visual (camera) and connectivity (Bluetooth™) functions of the earpiece 10.

FIG. 2 shows a more developed design of an earpiece 20 than earpiece 10. Similar to earpiece 10, earpiece 20 comprises a headset body 21, an adjustable boom 22, and a microphone 23. The earpiece 20 also comprises a camera 24, again positioned to see what the user would see. The camera 24, in this embodiment, is integrated within the body 21 of the earpiece 20. The body 21 also comprises internal wireless technology (not shown) for communication with an associated mobile phone and an internal speaker (not shown) for transmitting sound to a user wearing the earpiece.

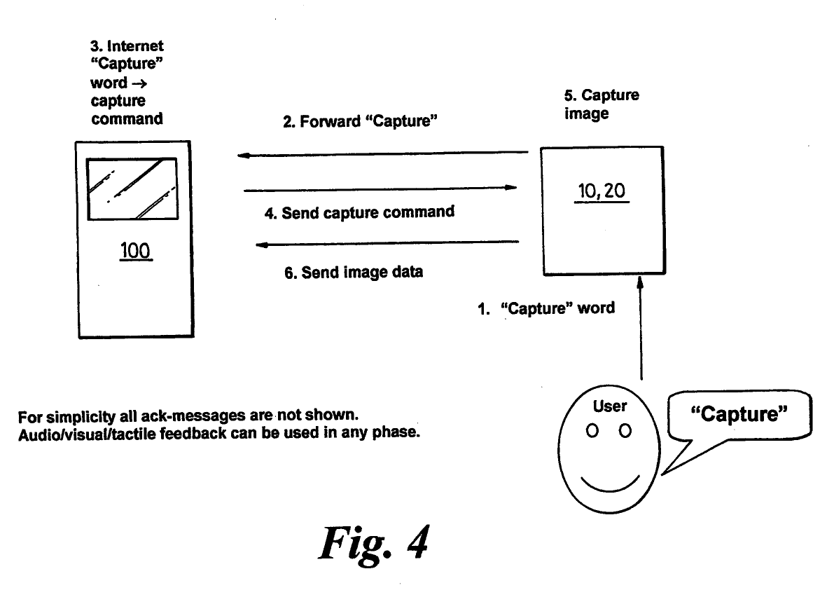

In the embodiment of FIG. 2, the body 21 also comprises a volume control 25 to adjust the volume level to the ear of the user, an answer on/off control switch 26 to activate the earpiece 20, and a camera on/off control switch 27. In an alternative embodiment (not shown, but described in relation to FIG. 4), the switch 27 maybe used to activate the capture of voice commands. This may of course be provided by actuation of switch 26, e.g. a long depression of switch 26.

Associated circuitry/components are housed within the earpiece body 21, as within the earpiece body 11 of FIG. 1. One or more of the control switches 25, 26, 27, and associated circuitry, are arranged to provide “one-touch” control of associated functions. The earpiece also comprises an earloop 28 which extends from the body 21 and is used to wrap the earpiece 20 around the ear of a user to fix the earpiece 20 into use position.

In a further embodiment, switch 26 may have enable functionality. In this sense, upon activation, it triggers the wireless connectivity functionality in the earpiece to find devices with which the earpiece can associate. When it finds a device with which can associate, further switches/keys would need to be activated on either or both the earpiece or associatable device to confirm that association should take place between the earpiece and a particular associatable device. Upon association, bi-directional transfer of data between the earpiece and associated device is possible.

One or more of the switches may have dedicated enable functionality or perform enable functionality in addition to the other functionality described above. Enable functionality may be performed immediately upon turning on the earpiece by, for example, activation of switch 26. Activation of this switch 26 may also activate the camera 24 and microphone 23 (from a dormant low power or off state).

Activation of headsets functionality does not need to be initiated by a user pressing one or more on off switches. As long as the earpiece 20 is in a power on-state, earpiece functionality may be initiated by the associated/associatable device. For example, the associatable device may initiate connection, and once connection has been established, a user may perform operations on the associated device to control for example the camera. This may be, for example, to increase zoom, to power the camera to a fully on-state, or to capture one or more images.

It will be seen from FIG. 3, that the earpiece 20 and camera 24 are arranged to allow the camera 24 to see what the user sees when the earpiece is in the in-use position. In operation, a user actuates switch 27. This powers up the microphone 23 and camera 24. This also allows the microphone 23 to transmit any voice commands which may be uttered by a user. Without activation of the switch 27, the microphone 23 and camera 24 are in a powered-down state. This may mean that one or both these components are turned off. These voice commands are transmitted to the handset 100 (see FIG. 4) to which the earpiece 20 is associated. The handset 100 processes these signals and sends back appropriate control signals which operate the camera 24.

For example, in the case of the word “capture” uttered by a user, the handset 20 sends control signals to the camera 24 to take a still image. When the word “video” is recognised, the handset 20 sends control signals to the camera 24 to take a video image. Then on recognition of the word “stop” or “stop recording”, the handset 20 sends control signals to the camera 24 to stop the recording process. During the video recording process, the microphone 23 may be arranged to stay on, or turn off after a period of time. The headset 20 may be arranged to de-activate the microphone 23 manually, for example, by the pressing of switch 26 during the video recording process.

The earpiece 10, 20 may be arranged to directly transmit captured images to the associated handset. The use of one or more buffers in the earpiece 10, 20 may be used to facilitate this direct transmission. This may be for still and/or video images. Rather than storing images on the earpiece 10, 20 the present invention makes use of the storage capacity already available in the associated handset.

FIG. 4 illustrates the method that can be employed to operate the camera 14/24. The earpiece 10, 20 is associated with a mobile phone handset 100. The earpiece 10, 20 forwards the command “capture” uttered by a user. The handset 100 processes and thereby interprets the command “capture” and provides an appropriate control signal back to the earpiece 10, 20. Upon reception of this control signal, the earpiece 10, 20 acts to capture the image by appropriately activating camera 14/24. Once captured, the captured image is sent back to the handset 100 for onward transmission over an air interface (e.g. GPRS). This onward transmission may be “real-time” or delayed.

It will be appreciated that embodiments of the present invention integrate a miniature camera into a headset, the headset being connectable to and controlled by the connected mobile handset device wirelessly.

The present invention will be particularly useful in the following usage scenarios:

### Scenario 1: User at Football Match

A user watching a football match in which his favourite team, Team A, score a goal. The user can call his friend who supports a rival team, Team B, and can stream the crowd celebrating while he is in conversation with his friend, and while he continues to watch the match.

### Scenario 2: Visual Meeting

The present invention would facilitate in decision making when not all parties involved in the decision making process could go to a remote site for a meeting. So, for example, live streaming of possible locations for a photo shoot, building development, analyzing production problems in factory, could be conveniently discussed with parties not all at the location in order for an informed decision to be made.

### Scenario 3: Sporting Moments

Friends at a Golf tournament, such as ‘The Open’, could follow different players, e.g. Player T and Player F. If the friend watching Player T call his friend before an important putt, they can both watch the event together. The other friend can also show a subsequent or earlier (from a recording) sliced shot by player F.

A group of friends are at the cricket match. When one is sent to get the drinks, another can stream video of the game to him so he doesn't miss any action while in the beverage queue. The friend still watch the game can also conveniently save snippets after they've happened e.g. wickets, to make sure their friend misses nothing important.

### Scenario 4: World Travel

A student taking a ‘year out’ travelling the world prior to going to university can regularly call up parents/friends to show them the things that the student is doing/seeing, where the student is staying etc.

If the time zones mean they are unable to call during the day, the student could record a video diary greeting/message and email for later streaming to share the experience at a more convenient time. The greeting/message could be conveniently stored for safe-keeping in the associated electronic device (such as the phone, rather than keeping all the data on the headset which is more visible and could get lost/stolen). The greeting/message could be stored in a removable memory card in the headset or in the associated electronic device.

The inventors of the present invention want to expand the usefulness of the earpiece by inserting an imaging device into the earpiece. In order to control the camera, it is not always practical to have all the necessary hardware inside the camera, as this would occupy too much space making the earpiece large. The inventors have therefore suggested that the earpiece can be used to initiate the activation of the camera, by providing a two way link between the earpiece and the handset so that a user may use audio commands which are sent to the handset and those commands are used to activate functionality of the camera (inside the earpiece) by means of control signals sent back to the earpiece.

It will be appreciated that embodiments of the present invention provide the following advantages:
Freedom to record/stream ‘see what I see’ whilst viewing an event yourself without having to concentrate on how to take video
Ability to ‘see what I see’ whilst on the move, working, at a football match, sightseeing etc.
Freedom to communicate with talk/listen and capture ability via a wireless headset
Ability to take photos/videos discretely
Longer usage of the device as the user is free to do other activities.
Wireless controllability & connectivity between headset and handset
The user can record/send/stream ‘see what I see’ whilst in conversation
Freedom to capture video/stills leaving the hands free to do other activities
Can take video/stills discretely

Aspects of mobile phone design are well known and will not be covered in any detail here. Aspects of other portable electronic devices are also known and are not described here. However, the present invention advantageously uses one or more existing processors, which provide the functionality of the electronic device, to process and provide the control signalling back to the headset/earpiece. The processing operation may include recognition of the command from the earpiece, and interpreting and providing an appropriate control signal to control camera functionality.

It will be appreciated that various modifications could be made to the headset design without departing from the scope of the present invention. For example, the headset may have adjustable straps to fit around a user's head. The headset may be arranged to be associated with one or more electronic devices, such as mobile phones, MP3 players, laptops etc. It will be appreciated that appropriately coded computer programs in the earpiece and handset will be used to perform the invention.

1. An electronic headset comprising connectivity functionality, the connectivity functionality arranged to allow the headset to be operatively coupled to a remote associated electronic device for the transmission of signalling between the headset and the device, the headset further comprising camera functionality arranged to capture one or more images, and wherein the camera functionality is arranged to be controlled by control signalling transmitted via the connectivity functionality, the control signalling being processed by the remote associated electronic device and being sent to the electronic headset to control the camera functionality.

2. A headset according to claim 1, wherein the headset is arranged to receive function commands to control headset functions.

3. A headset according to claim 2, wherein function commands comprise one or more voice commands and or actuation switch commands.

4. A headset according to claim 2, wherein the function commands originate from an associatable remote electronic device.

5. A headset according to claim 2, wherein the function commands originate at the headset.

6. A headset according to claim 2, wherein the function commands include enable functionality to activate connectivity between the headset and an associatable electronic device.

7. A headset according to claim 1, wherein the headset is arranged to transmit function commands to the associated electronic device for processing of the function commands by the device to generate control signalling sent back to the headset to control camera functionality.

8. A headset according to claim 7, wherein the function command comprises one or more switch commands, and wherein the switch comprises a switch/button which is used to activate the camera functionality, and wherein activation of the switch command is processed by the associated device and appropriate control signals are sent back to the headset.

9. A headset according to claim 7, wherein the function command comprises one or more switch commands, and wherein the switch command is arranged such that voice commands are transmitted to the associated electronic device when the switch command is in an “on” status.

10. A headset according to claim 7, wherein the function command comprises one or more switch commands, and wherein the switch command is arranged such that voice commands are not transmitted to the associated electronic device when the switch command is in an “off” status.

11. A headset according to claim 1, wherein the headset comprises audio functionality arranged to receive audio input from a user of the headset, the headset being arranged to transmit the audio input to the associated electronic device via the connectivity functionality for processing, to provide control signalling to be sent back to the headset.

12. A headset according to claim 1, wherein the headset comprises audio functionality arranged to distinguish between audio inputs from a user, and determine that only those audio inputs corresponding to audio commands are to be transmitted to the associated electronic device.

13. A headset according to claim 1, wherein the headset comprises a processor to distinguish and differentiate between audio voice commands.

14. A headset according to claim 1, wherein the headset comprises memory to store audio voice commands for use in the comparison with uttered audio voice commands.

15. A headset according to claim 1, wherein the headset is not adapted to distinguish/differentiate between camera function control inputs from a user and is adapted to rely on the associated electronic device to interpret the input from the user.

16. A headset according to claim 1, wherein the headset is not adapted to distinguish/differentiate between audio inputs from a user and is adapted to rely on the associated electronic device to interpret the input from the user.

17. A headset according to claim 1, wherein the headset comprises audio functionality arranged to provide audio output to a user of the headset, and the connectivity functionality is arranged to be operatively coupled to an associated electronic device for the transmission of audio signalling from the associated electronic device to the electronic headset to provide the audio output to the user.

18. A headset according to claim 11, wherein the headset comprises audio functionality arranged to provide audio output to a user of the headset, and the connectivity functionality is arranged to be operatively coupled to an associated electronic device for the transmission of audio signalling from the associated electronic device to the electronic headset to provide the audio output to the user, and wherein the audio input is arranged to control audio output functionality.

19. A headset according to claim 1, wherein the headset is arranged to perform a particular camera function on receipt of an appropriate audio voice command.

20. A headset according to claim 1, wherein the headset is arranged to store one or more images in the headset.

21. A headset according to claim 1, wherein the headset is arranged to transmit one or more images via the connectivity functionality to the remote associated device.

22. A headset according to claim 1, wherein the headset is arranged to transmit one or more images via the connectivity functionality to the remote associated device for storage, processing, or further transmission of one or more of the image by the remote associated device.

23. A headset according to claim 1, wherein the headset is arranged to directly transmit captured images to the associated handset.

24. A headset according to claim 23, wherein the headset comprises one or more buffers arranged to facilitate the direct transmission.

25. A headset according to claim 1, wherein the headset is arranged to provide live transmission of one or more of the images to the connectivity functionality.

26. A headset according to claim 1, wherein the connectivity functionality is wired.

27. A headset according to claim 1, wherein the connectivity functionality is wireless.

28. A headset according to claim 1, wherein the connectivity functionality is provided by short-range radio wave transmission.

29. A headset according to claim 1, wherein the associated electronic device is a mobile handset conforming to one or more telecommunications standards.

30. A headset according to claim 1, wherein the associated electronic device is a music player.

31. A headset according to claim 1, wherein the associated electronic device is a portable computer.

32. A headset according to claim 1, wherein the headset is an earpiece.

33. A headset according to claim 1, wherein the headset comprises a microphone and speaker.

34. A headset according to claim 1, wherein the control signalling allows the capture of still and/or moving visual images by the camera functionality.

35. A headset according to claim 1, wherein the control signalling allows control of power to the electronic headset.

36. A headset according to claim 1, wherein the camera functionality comprises digital and/or optical zoom, which is controllable by the associated electronic device.

37. A headset according to claim 1, wherein the camera functionality is arranged to move to across a scene to take images independently of the motion of a user.

38. A headset according to claim 1, wherein the camera functionality is arranged to be positioned to take images corresponding to what the user can see.

39. An electronic device having connectivity functionality, the connectivity functionality arranged to allow the electronic device to be operatively coupled to a remote electronic headset for the transmission of signalling between the device and the headset, the device further comprising control functionality arranged to process headset camera control signalling to control the operation of headset camera functionality for the capture of one or more images, the control functionality being arranged to transmit the control signalling via the connectivity functionality.

40. A computer program for operation on a headset for providing headset camera functionality as claimed in claim 1.

41. A computer program for operation on electronic device according to claim 39 for providing headset camera functionality.

42. A method of configuring camera functionality in a headset according to claim 1.

43. A method of configuring an electronic device according to claim 39 for controlling camera functionality in a headset.

44. A headset as hereinbefore described with reference to the accompanying Figures.

45. An electronic device as hereinbefore described with reference to the accompanying Figures.
